(19) United States
(12) Patent Application Publication
(10) Pub. No.: US 2009/0012715 A1
(43) Pub. Date: Jan. 8, 2009

(54) Prediction model of graft survival

(76) Inventor: Alexander S. Goldfarb-Rumyantzev, Salt Lake City, UT (US)

Correspondence Address: Workman Nydegger, 1000 Eagle Tower, 60 East South Temple, Salt Lake City, UT, 84111, US

(21) Appl. No.: 11/709,538

(22) Filed: Feb. 21, 2007

Related U.S. Application Data
(63) Continuation-in-part of application No. 11/259,484, filed on Oct. 26, 2005.
(60) Provisional application No. 60/622,063, filed on Oct. 26, 2004.

(51) Int. Cl. G06F 17/18; G06F 19/00

(52) U.S. Cl. 702/19; 702/181

(57) ABSTRACT

Described are methods of predicting graft survival based on pre-transplant variables. A logistic regression (LM) and/or a tree-based model (TBM) are used to identify predictors of graft survival and to generate prediction algorithms. Both the logistic regression model and the tree-based model may be used in clinical practice for long term prediction of graft survival based on pre-transplant variables. The invention is also directed to computer software, which includes a logistic regression model and/or a tree-based model to select pre-transplant variables and generate a graft survival algorithm and to calculate a graft survival probability, and for selecting appropriate organ donors and recipients to optimize the graft survival probability.

### CROSS-REFERENCE TO RELATED APPLICATIONS

This application is a continuation-in-part of co-pending U.S. patent application Ser. No. 11/259,484, filed Oct. 26, 2005, which itself, pursuant to the provisions of 35 U.S.C. § 119(e), claims the benefit of the filing date of provisional patent application Ser. No. 60/622,063, filed Oct. 26, 2004, the contents of the entirety of each of which are incorporated herein by this reference.

### TECHNICAL FIELD

The invention relates to the field of models for predicting the overall probability of a tissue or organ graft surviving a certain period of time. More particularly, this invention is directed to a model using an algorithm to account for predictors available before an organ transplant to estimate the probability of graft survival.

### BACKGROUND

Improved immunosuppression has reduced acute rejection, but has had little effect on late graft loss (1). Causes of long-term allograft failure include recurrent disease and chronic allograft nephropathy. Pre and post-transplant predictive factors of graft survival have been extensively studied in adults (2, 3) and children (4-6). These studies were based on data from the United Network of Organ Sharing (UNOS) and North American Pediatric Renal Transplant Cooperative Study (NAPRTCS). Many of these studies focused on specific predictive factors such as donor age (7, 8), hypertension (HTN), diabetes mellitus (DM)(9), non-heartbeating donor (10), cold storage time (11), body mass index (BMI) of donor and recipient (12), and high degree of donor vascular pathology (13). Many of these factors were associated with worse outcomes in multivariate analyses.

Other graft recipient factors important to graft survival include recipient's general health (14), race (15), underlying kidney disease (16), and previous treatment modalities. Additional high-risk factors that have been considered include re-transplant (17), multiple (>5) pre-transplant blood transfusions (18), human leukocyte antigen-B and DR (HLA) mismatch, and advanced recipient age (19). Pre-transplant dialysis modality may impact patient outcome (20), while pre-emptive transplantation of kidneys from living donors is associated with longer allograft survival (21). The relationship between donor and recipient age, race, gender, and three-year graft survival has been previously reported (7, 30), and is non-linear. The effect of cold ischemia time was also previously reported (11). BMI of donor and recipient as well as recipient obesity in relation to outcome has been discussed in literature and found to have an important role in the prediction of kidney allograft outcome in some studies (12, 33), while in others obese (high BMI) transplant recipients have similar outcomes to non-obese patients (34).

Attempts have been made to develop prediction models of graft survival (mostly short-term) (24) based on data available using different statistical models, such as Cox regression (25), and artificial neural networks (26). Similar data derived from univariate and multivariate analyses was used in a smaller study for cadaveric kidney allocation in a Northern Italy Transplant Program (36).

The references discussed herein are provided solely for their disclosure prior to the filing date of the present application. Nothing herein is to be construed as an admission that the inventors are not entitled to antedate such disclosure by virtue of prior invention.

All references, including publications, patents, and patent applications, cited herein are hereby incorporated by reference to the same extent as if each reference were individually and specifically indicated to be incorporated by reference and were set forth in its entirety herein.

It would be desirable to provide an accurate comprehensive model for predicting the probability of graft survival over a period of time. It would also be desirable to develop a graft survival model based on available pre-transplant variables that may be used to counsel potential graft recipients before a transplant procedure. Furthermore, it would be desirable to develop computer software that would include a graft survival model for use in a transplant program.

### SUMMARY OF THE INVENTION

Disclosed is a prediction algorithm used to predict graft survival based on pre-transplant variables only. Logistic regression models (LM) and tree-based models (TBM) may be used to select predictor variables and for the generation of prediction algorithms. Predictor variables may include, but are not limited to, recipient race, gender, age, height, weight, recipient having a transplant prior to the current one (yes/no), total number of transplants (including the current one), the time recipient has been on the list prior to transplant, predominant renal replacement therapy modality, percent time on peritoneal dialysis prior to transplant, number of renal replacement therapy modalities used prior to transplant, the specific combination of renal replacement therapy modalities, recipient comorbidity score, history of cardiovascular disease, history of unstable angina, history of diabetes, history of hypertension, presence of hepatitis B core antibodies, presence of hepatitis C antibodies, peak and mean level of panel reactive antibodies, primary source of pay for medical services, donor variables including race, gender, age, height, weight, donor type (living or deceased), and transplant procedure variables including cold ischemia time, number of matched HLA antigens, the use of MMF in the immunosuppressive regimen, and other suitable variables.

The desired predictor variables and the prediction algorithms may be incorporated into a transplant program or a clinical practice for long-term prediction of allograft survival for candidate donors and potential recipients. In one example embodiment, the allograft is a kidney. The prediction algorithms and the predictor variables may also be incorporated into a computer software program or medical record system enabling the health care practitioner to evaluate a patient's situation and advise the best course of action. Graft survival predictions may be used to counsel potential organ recipients before or after putting them on the transplant list or to counsel a potential organ recipient as to whether or not to go ahead and accept an available organ for transplantation rather than waiting for another organ.

Further disclosed is a method of providing decision support for a graft implantation. Such a method may comprise selecting pre-transplant variables; calculating the probability of graft survival for each of more than one graft survival algorithm; and using the calculated the probability of graft survival to aid in a decision to implant a graft.

### BRIEF DESCRIPTION OF THE FIGURES

While the specification concludes with claims particularly pointing out and distinctly claiming that which is regarded as the present invention, the advantages of this invention and the best mode can be more readily ascertained from the following detailed description when read in conjunction with the accompanying drawings in which:

FIGS. 1A and 1B are graphical representations of how three-year graft survival varies with donor and recipient age. FIG. 1A graphically illustrates the three-year graft survival (%) and total number of kidney transplants vs. cadaver donor age. FIG. 1B graphically illustrates the three-year graft survival (%) and total number of transplants vs. recipient age.

FIGS. 2A-2C are graphical representations of bivariate analysis for three-year graft survival (%) and relative body mass index (BMI), transplant center volume, and cold ischemia time. FIG. 2A graphically represents the relationship between donor-to-recipient BMI category and three-year graft survival with each dot representing a donor/recipient BMI category. Each of the 25 categories have the same number of patients (n=1496). FIG. 2B graphically represents the three-year graft survival and transplant center volume (total number of transplants with known outcomes over a study period) and FIG. 2C graphically represents the relationship of cold ischemia time and three-year graft survival.

FIG. 3 is a graph representing the odds ratios of the three-year graft survival for a selection of prediction variables.

FIG. 4 shows the results of the prediction of three-year graft survival using a logistic regression model on the testing dataset. All patients were divided into ten groups based on predicted probability of graft survival. The observed group-averaged graft survival is compared with the predicted probability.

FIG. 5 shows the results of the prediction of three-year graft survival using a tree-based model on the testing dataset. All patients are divided into seven groups based on predicted probability of graft survival. The observed group-averaged graft survival is compared with the predicted probability.

FIG. 6 is a diagram representing a tree-based model built using the training dataset. D—donor, R—recipient, Tx—transplant, CIT—cold ischemia time, “Y” and “N” at the terminal nodes of the tree correspond to predicted three-year graft survival (yes/no). The list of end-stage renal disease cause categories is presented in the Appendix. Transplant procedure group 1: left/right/en-bloc kidney with/without the whole pancreas with duodenum or whole pancreas with duodenal patch/left kidney. Transplant procedure group 2: double kidneys, pancreas segment with left kidney, whole pancreas with duodenum and double kidneys, whole pancreas with right kidney. Transplant procedure group 3: pancreas segment and left kidney, whole pancreas with duodenum and right/en-bloc kidney, whole pancreas and left kidney Transplant procedure group 4: left/right/en-bloc kidney, whole pancreas with duodenum and left kidney, whole pancreas with duodenal patch and left kidney, whole pancreas and right kidney.

FIGS. 7A-7E show bar plots of the graft survival rates vs. predicted probability of graft survival for one (FIG. 7A), three (FIG. 7B), five (FIG. 7C), seven (FIG. 7D), and ten (FIG. 7E) years. Predictions were generated in the independent testing dataset, separate from the training dataset upon which the models were created.

FIGS. 8A-8E depict ROC curves for the prediction models of the one (FIG. 8A), three (FIG. 8B), five (FIG. 8C), seven (FIG. 8D), and ten (FIG. 8E) years of graft survival. ROC curves were generated in the independent testing dataset, separate from the training dataset upon which the models were created.

### DETAILED DESCRIPTION OF EXAMPLE EMBODIMENTS OF THE INVENTION

While this invention is described in the following detailed examples of embodiments, such embodiments are illustrative only and do not limit the invention which is defined by the claims. The present invention can be further modified within the spirit and scope of this disclosure.

One example embodiment of the present invention provides a method of estimating the probability of organ and tissue graft survival using pre-transplant variables. Examples of methods according to the present invention may use a logistic regression model (LM) and/or a tree-based model (TBM). Several features make TBMs a powerful tool for building prediction algorithms that may be successfully used in practice. TBMs work best when the regression variables are a mixture of categorical and continuous variables, and are often able to uncover complex interactions between predictors, which may be difficult or impossible to do using traditional multivariate techniques. A TBM algorithm is non-parametric, so no assumptions are made regarding the underlying distribution of values of the predictor variables. TBMs identify splitting variables based on an exhaustive search of all possibilities, even in problems with many hundreds of possible predictors. Simultaneously, it requires relatively little input from the analyst. This graphical algorithm, presented as a collection of simple binary rules, is much simpler to interpret by a non-statistician than the multivariate LM. Thus it may be used in decision-making without doing any additional calculations, and therefore is more likely to be followed in clinical practice.

A further embodiment of the present invention provides a method of providing decision support for a transplant. Embodiments of method of providing decision support for a transplant may include one or more models for predicting organ and/or tissue graft survival. Examples of models for predicting organ and/or tissue graft survival include, but are not limited to LMs, TBMs, Artificial Neural Networks, and Generalized Additive Models. In embodiments of the invention, outcomes from one or more models for predicting organ and/or tissue graft survival may be generated together and displayed at one time, averaged together, or otherwise manipulated to provide a “vote” or average of the models used.

### Example 1

Patients were selected with end-stage renal disease (ESRD) that underwent kidney or kidney-pancreas transplantation and were listed on the US Scientific Registry of Transplant Recipients supplied by UNOS. The dataset includes transplants performed in infants and young children (minimal age <1 year; maximum age 98 years). Independent variables (see Table 4) available for analysis included: age, gender, race, height, and weight for both donor and recipient, recipient cause of ESRD (Table 1), type of pre-transplant renal replacement therapy, number of previous kidney transplants and pre-transplant blood transfusions, recipient's most recent creatinine and donor's terminal creatinine, history and duration of diabetes and HTN in the donor, number of HLA match and mismatch, cold ischemia time, kidney or kidney-pancreas transplant, and transplant center code. One of skill in the art will recognize that the independent predictor variables are exemplary only and may be added to or modified as necessary or desired.

TABLE 1
End-stage renal disease (ESRD) cause categories, based on the total
transplant number (n) for the specific diagnosis

| | |
|---|---|
| Category 1 | Radiation nephritis, lymphoma |
| (n = 1-5) | |
| Category 2 | Progressive systemic sclerosis, Wilms tumor, myeloma, |
| (n = 6-12) | antibiotic-induced nephritis, cancer chemotherapy induced nephritis, |
| | polyarteritis, urolithiasis |
| Category 3 | Nephrophthisis, gout, incidental carcinoma, cortical necrosis, heroin |
| (n = 13-22) | nephrotoxicity, renal artery thrombosis |
| Category 4 | Mesangio-capillary type 2 glomerulonephritis, cystinosis, Fabry's disease, |
| (n = 23-27) | sickle cell anemia, Goodpasture's syndrome, sarcoidosis |
| Category 5 | Oxalate nephropathy, amyloidosis, renal cell carcinoma, acute tubular |
| (n = 28-46) | necrosis, scleroderma, nephrolithiasis |
| Category 6 | Familial nephropathy, Henoch-Schonlein purpura, prune belly syndrome, |
| (n = 47-77) | type 2 diabetes (insulin-dependent adult onset), membranous |
| | nephropathy, analgesic nephropathy, cyclosporin nephrotoxicity |
| Category 7 | Mesangio-capillary type 1 glomerulonephritis, anti-GBM disease, |
| (n = 78-196) | hemolytic uremic syndrome, medullary cystic disease, chronic |
| | glomerulosclerosis unspecified, Wegeners granulomatosis |
| Category 8 | Idiopathic/post-infectious crescentic glomerulonephritis, membranous |
| (n = 197-541) | glomerulonephritis, hypoplasia/dysplasia/dysgensis/agenesis, acquired |
| | obstructive nephropathy, Alport's syndrome, chronic nephrosclerosis- |
| | unspecified, congenital obstructive uropathy |
| Category 9 | IgA nephropathy, chronic pyelonephritis/reffux nephropathy, systemic |
| (n = 542-1176) | lupus erythematosus, malignant HTN, retransplant/graft failure |
| Category 10 | Focal glomerularscherosis, polycystic kidneys, type 1 diabetes |
| (n = 1177-7777) | (insulin-dependent juvenile onset), type 2 diabetes (non-insulin-dependent |
| | adult onset), hypertensive nephrosclerosis, chronic glomerulonephritis |
| | unspecified, other |

Statistical analysis. Bivariate analysis was performed using cross-tabulation and comparison of graft survival in the subgroup using the chi-square test. The Friedman supersmoothing method was used to fit the curve in bivariate analysis. Discrimination was determined by the area under the receiver operating characteristic (ROC) curve and chi-square for LM models. Model calibration was assessed using the Hosmer-Lemeshow goodness-of-fit test. For the purpose of prediction analysis, all records were randomly assigned either to a training set (n=25,000) used for knowledge acquisition and model development, or to a testing set (n=12,407) used to validate the models.

Predicted probabilities of three-year graft survival were generated on a testing set and compared with the actual patient outcomes. The predicted probability of graft survival with group-average observed graft survival was used to compare the performance of the models. Also 2×2 contingency tables were used to determine positive and negative predictive values (PV).

Statistical methods that may be used in certain embodiments of the present invention include, but are not limited to, LM and classification trees. In certain situations, traditional statistical methods are poorly suited for complex interactions or detecting patterns in the data. Many possible predictor variables may violate the normality assumptions necessary for parametric analysis. In addition, the results of traditional methods sometimes may be difficult to use. Therefore, along with a traditional regression model that assumes a linear relationship between predictors and the outcome, a TBM was used, which does not require the linearity assumption (28). TBM is an exploratory technique for uncovering structure in data, which generates a collection of many rules displayed in the form of binary tree (29).

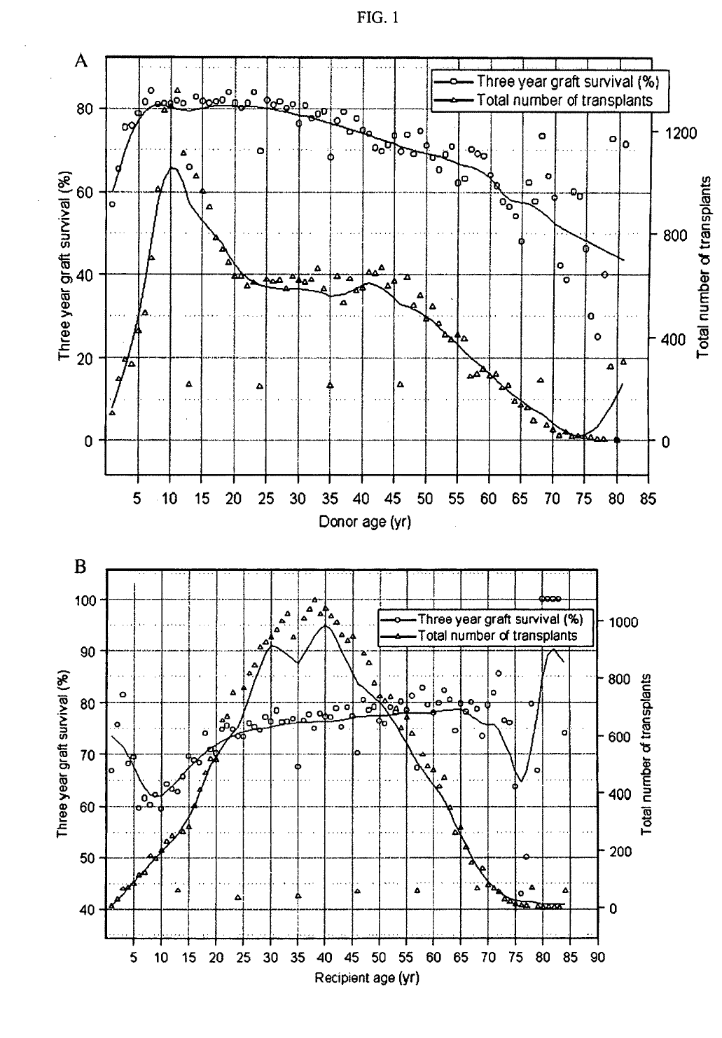

Bivariate analysis-donor and recipient characteristics. Young and old donors and recipients have lower three-year graft survival (p<0.001) (FIGS. 1A and 1B). There were differences in outcome associated with donor and recipient gender (Table 2) and race (Table 3). Kidneys from donors with both diabetes mellitus (DM) and HTN had the worst three-year survival (59.3%), while those from donors without either had the best outcome (76.3%). Kidneys from either diabetic or hypertensive donors were roughly in the middle (66.2 and 64.3%, respectively) (p<0.001). Increased duration of HTN and/or diabetes (from 1 to 5 years by one-year increments) in the donor was associated with worse outcome (p<0.001 for both). There is no relationship between donor's terminal creatinine and graft survival. There were differences in outcome associated with different etiologies of renal failure (data not shown). Patients with no dialysis history (pre-emptive transplant) had the best three-year graft survival (81.3%, n=1,940) followed by those with a history of peritoneal dialysis (76.1%, n=4,591) and then hemodialysis (73.0%, n=11,542) (p<0.001). A previous transplant worsened three-year survival in almost a linear fashion with 76.7% survival in the recipient with no previous transplant history, 70.9, 62.1, and 56.9% in those with one, two and more than two previous transplants, respectively (p<0.001). Number of pre-transplant transfusions did not significantly affect graft survival in bivariate analysis.

TABLE 2
Donor and recipient gender and three-year graft survival (%).

| | |
|---|---|
| Recipient | Donor |

| | Total | Percent | Total | Percent |
|---|---|---|---|---|
| Gender | number | survival | number | Survival |
| Female | 14,961 | 75.7 | 14,202 | 73.6 |
| Male | 22,446 | 76.7 | 23,205 | 77.9 |

TABLE 3
Donor and recipient race and three-year graft survival (%).

| | |
|---|---|
| Donor | Recipient |

| | Total | Percent | Total | Percent |
|---|---|---|---|---|
| Race | number | survival | number | Survival |
| White | 29,796 | 77.2 | 23,322 | 79.2 |
| Black | 3,968 | 69.7 | 8,852 | 67.0 |
| Hispanic | 2,943 | 75.4 | 3,493 | 78.2 |
| Asian | 432 | 73.6 | 1,194 | 81.0 |

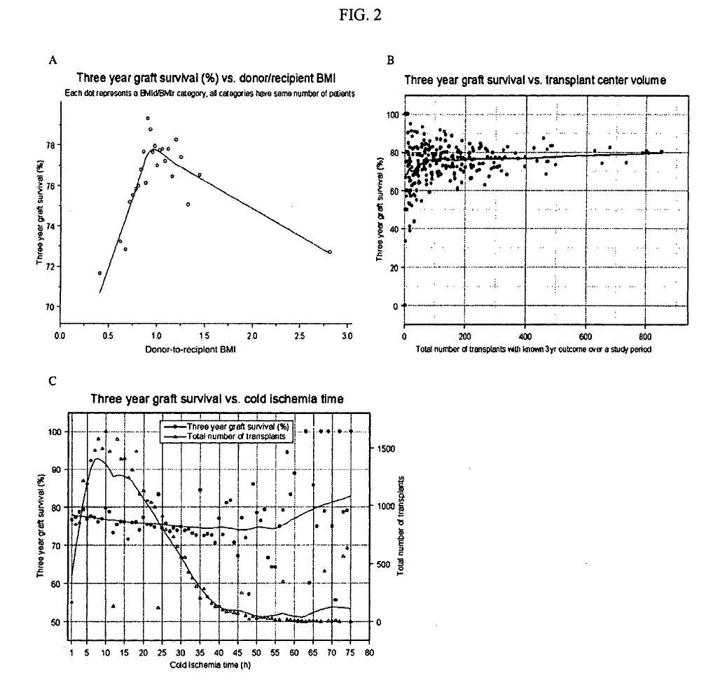

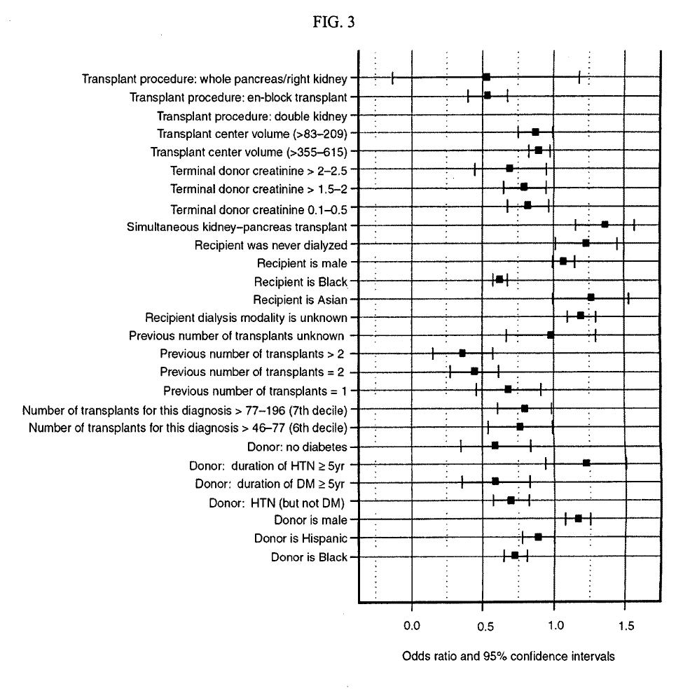

Transplant procedure, matching donor and recipient. The three-year survival improves and declines in linear fashion with increasing number of matched and mismatched antigens, respectively (p<0.001). Donor/recipient BMI vs. three-year graft survival looks almost like a bell-shape curve with the best outcome associated with the donor/recipient BMI=1 (FIG. 2A). The worst survival was in grafts from relatively small donors to large recipients (p<0.001). Transplant centers with a low volume of transplants had variable outcome, while in those with high number of transplants the outcome was relatively uniform (FIG. 2B). There was a slight downward trend in relation of three-year graft survival to cold ischemia time (FIG. 2C). Recipients of kidney-pancreas transplants had better three-year kidney survival (82.5%, n=3,243) than those receiving a single (75.7%, n=33,526) or en-bloc kidneys (68.2%, n=638) (p <0.001).

### Example 2

Multivariate analysis—logistic regression model (LM). Using stepwise forward selection, a significance level of 0.05 was set for independent variables to enter the model. The variables and model information are presented in Table 4. Odds ratios with 95% confidence intervals (CI) for the binary variables identified by the model are presented graphically (FIG. 3). Causes of ESRD (Table 1) in categories that demonstrated <70% three-year survival are: membranous nephropathy (66.2%), cyclosporin nephrotoxicity (68.3%), analgesic nephropathy (68.8%), type II insulin-dependent DM (65.6%), Henoch-Schonlein purpura (69.7%), mesangio-capillary type 1 glomerulonephritis (68.5%), hemolytic uremic syndrome (54.8%).

Model discrimination using the c index (area under the receiver operating characteristic curve) was 0.653. This is the probability that for a randomly chosen pair of patients, the predicted and observed graft survival are concordant. Model calibration was assessed using the Hosmer-Lemeshow goodness-of-fit test. As the p value, p=0.63, of this test was not significant, the model's estimated probabilities of three-year graft survival are not significantly different from the actual survival of patients over groups spanning the entire range of probabilities.

TABLE 4
Predictors of the outcome (three-year graft survival) identified by logistic regression.

| Independent variable | Coefficient | X² | ρ | Odds ratio | 95% CI |
|---|---|---|---|---|---|
| Intercept | 1.332 | 89.474 | <0.0001 | | |
| Donor age | −0.0145 | 297.87 | <0.0001 | | |
| Donor BMI | 0.0015 | 9.0748 | 0.0026 | | |
| Recipient BMI | −0.0121 | 42.774 | <0.0001 | | |
| Recipient age | 0.0146 | 231.46 | <0.0001 | | |
| HLA match | 0.1336 | 206.65 | <0.0001 | | |
| Cold ischemia time | −0.0079 | 35.701 | <0.0001 | | |
| Recipient is male | 0.0648 | 6.4246 | 0.0113 | 1.067 | 1.015-1.122 |
| Donor is male | 0.1467 | 30.611 | <0.0001 | 1.158 | 1.099-1.22 |
| Terminal donor creatinine 0.1-0.5 | −0.2087 | 10.343 | 0.0013 | 0.812 | 0.715-0.922 |
| Terminal donor creatinine >1.5-2 | −0.2389 | 12.579 | 0.0004 | 0.787 | 0.69-0.899 |
| Terminal donor creatinine >2-2.5 | −0.4012 | 8.8319 | 0.003 | 0.67 | 0.514-0.872 |
| Previous number of transplants = 1 | −0.4078 | 11.241 | 0.0008 | 0.665 | 0.524-0.844 |
| Previous number of transplants = 2 | −0.8534 | 35.723 | <0.0001 | 0.426 | 0.322-0.564 |
| Previous number of transplants > 2 | −1.1078 | 25.17 | <0.0001 | 0.33 | 0.214-0.509 |
| Previous number of transplants unknown | −0.0454 | 0.1503 | 0.6982 | 0.956 | 0.76-1.202 |
| Donor is Black | −0.3229 | 66.57 | <0.0001 | 0.724 | 0.67-0.782 |
| Donor is Hispanic | −0.1247 | 7.1664 | 0.0074 | 0.883 | 0.806-0.967 |
| Recipient is Black | −0.4726 | 263.48 | <0.0001 | 0.623 | 0.589-0.66 |
| Recipient is Asian | 0.2201 | 8.065 | 0.0045 | 1.246 | 1.071-1.451 |
| Recipient was never dialyzed | 0.2001 | 9.7585 | 0.0018 | 1.222 | 1.077-1.385 |
| Recipient dialysis modality is unknown | 0.1754 | 33.774 | <0.0001 | 1.192 | 1.123-1.264 |
| Donor: HTN (but not DM) | −0.3701 | 32.775 | <0.0001 | 0.691 | 0.608-0.784 |
| Donor: no DM | −0.571 | 13.845 | 0.0002 | 0.565 | 0.418-0.763 |
| Donor: duration of DM ≧5 years | −0.5702 | 14.815 | 0.0001 | 0.565 | 0.423-0.756 |
| Donor: duration of HTN ≧5 years | 0.1856 | 4.7968 | 0.0285 | 1.204 | 1.02-1.421 |
| Simultaneous kidney-pancreas transplant | 0.3052 | 30.044 | <0.0001 | 1.357 | 1.217-1.513 |
| Transplant procedure: en-bloc transplant | −0.6445 | 47.954 | <0.0001 | 0.525 | 0.437-0.63 |
| Transplant procedure: double kidney | −12.727 | 0.021 | 0.8849 | <0.001 | >999.99 |
| Transplant procedure: whole pancreas/right kidney | −1.413 | 3.9032 | 0.0482 | 0.243 | 0.06-0.989 |
| Transplant center volume (>83-209) | −0.1436 | 8.2045 | 0.0042 | 0.866 | 0.785-0.956 |
| Transplant center volume (>355-615) | −0.1115 | 14.812 | 0.0001 | 0.895 | 0.845-0.947 |
| Number of transplants for this diagnosis >46-77 | −0.2942 | 7.2995 | 0.0069 | 0.745 | 0.602-0.922 |
| (6^{th} decile) | | | | | |
| Number of transplants for this diagnosis >77-196 | −0.2435 | 7.9364 | 0.0048 | 0.784 | 0.662-0.929 |
| (7^{th} decile) | | | | | |

BMI, body mass index
HLA, human leukocyte antigen
DM, diabetes mellitus
CI, confidence interval
HTN, hypertension

### Example 3

Prediction analysis—logistic regression (LM). To identify predictors of three-year graft survival and develop a prediction model using LM, 25,000 records were randomly selected as the training set, while the remaining 12,407 records were designated as a testing set and were used to compare predicted and observed three-year allograft survival. A LM model was again generated on the training set only. This model was 65% concordant, 34.5% discordant, and the c index was 0.653. Using the variables and parameter estimates generated with the training set, we calculated the probability of three-year graft survival in the testing set. All records were divided into ten groups based on deciles of predicted probability of graft survival (0-10%, >10-20%, >20-30%, etc.). The observed percentage of three-year graft survival was calculated for each group, and the observed graft survival was compared with the expected survival. As there was only one patient in the >10-20% group, that group was combined with the >20-30% group to produce a >10-30% group.

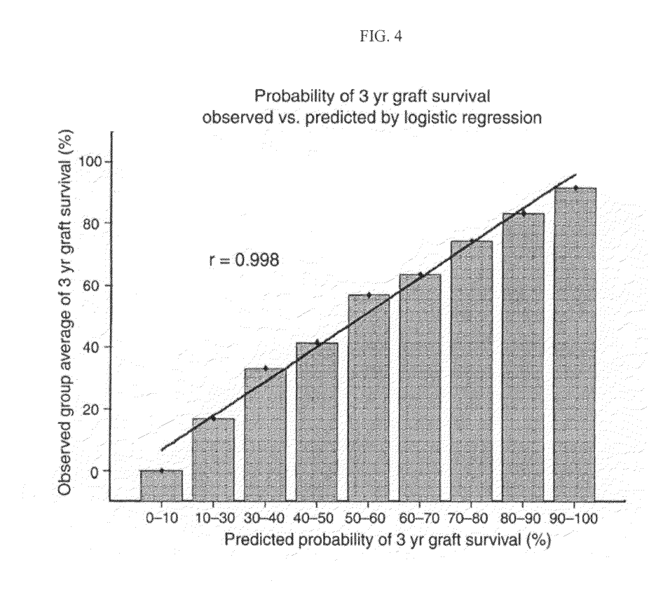

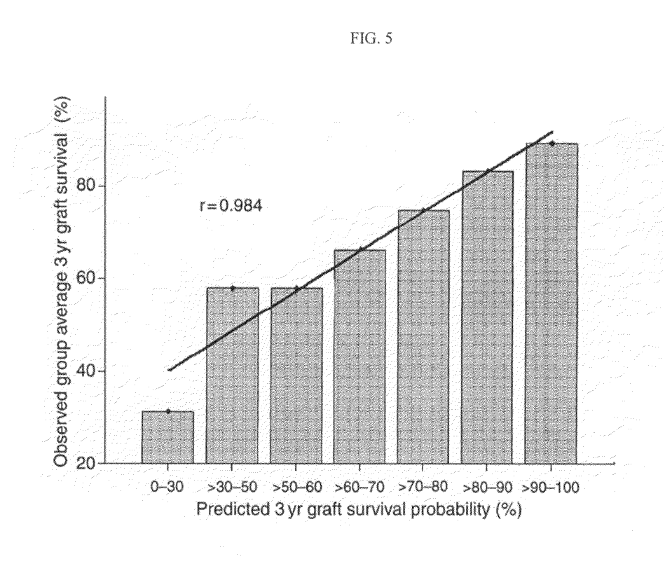

The midpoint of each group's probability range was used as the expected percent survival. As shown in FIG. 4 the prediction of the probability of graft survival from the training model achieved a very good match with the observed survival of the testing set, with a chi-square value of 6.15 and p=0.63, which shows no significant difference between observed and predicted category, and a correlation of r=0.998. The predicted allograft failure probability was converted into a binary variable (graft survival=“yes” or “no”) using a cut-point of 50% probability. The results were compared by means of a 2×2 contingency table. The positive PV of allograft survival with the model was 76% and the negative PV was 63%.

### Example 4

Prediction analysis—tree-based model. A TBM was used to identify predictors of three-year graft survival and develop a prediction model. The outcome of the cross-validation procedure in the form of deviance plotted against number of terminal nodes (tree size) was analyzed and the optimal size of the tree was determined to be equal to 54 terminal nodes. To identify predictors of the outcome, the initial tree was constructed on the whole dataset and pruned to 54 terminal nodes. The following 17 predictors of outcome (in order from the root of the tree to the terminal nodes) were identified by the TBM: recipient race, donor age, recipient weight, cold ischemia time, recipient height, previous number of transplants, recipient age, number of matched HLA antigens, donor race, cause of ESRD (Table 1), recipient gender, number of mismatched HLA antigens, recipient BMI, recipient weight, presence of diabetes and/or HTN, donor height, donor/recipient BMI. The residual mean deviance of the model is 1.03 and misclassification error rate was 0.23.

The new TBM was built upon a training set and validated on the testing set. Using the model generated with the training set, the probability of three-year graft survival was calculated in the testing set. All records were divided into ten groups based on deciles of predicted probability of graft survival (0-10%, >10-20%, >20-30%, etc.). The observed percentage of three-year graft survival was calculated for each group. The observed graft survival was compared with the expected survival. As there were only six patients in the 0-10% and >10-20% groups together, those groups were combined with the >20-30% group to produce a 0-30% group. For the same reason groups >30-40% and >40-50% were combined to produce >30-50% group. The midpoint of each group's probability range was used as the observed percent survival (FIG. 5).

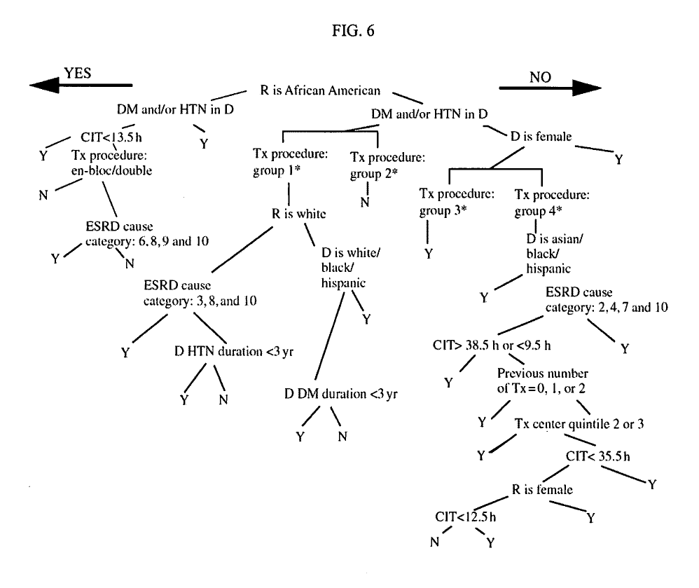

The prediction of the probability of graft survival from the training model achieved a good correlation with the observed survival of the testing set (r=0.984). The predicted allograft failure probability was converted into a binary variable (graft survival=“yes” or “no”) using a cut-point of 50% probability (FIG. 6). The graph represents the model in the form of a dichotomous tree, where each node presents a question regarding the value of a single independent variable. If the answer to the question is “yes” users move to the next node by way of the left branch (or right branch, if the answer is “no”) until it reaches the terminal node, which predicts three-year graft survival (Y or N). The results were compared by means of a 2×2 contingency table. The positive PV of allograft survival with the model was 76.0% and the negative PV was 53.8%.

### Example 5

### Modeling for 1, 3, 5, 7, and 10 Year Allograft Survival

### Methods:

### Dataset:

The data used were initially collected by United States Renal Data System (USRDS) and United Network of Organ Sharing (UNOS) of all kidney allograft recipients (both pediatric and adults), who underwent kidney or kidney-pancreas transplantation during the period of Jan. 1, 1990 through Dec. 31, 1999. The follow-up period was extended through Dec. 31, 2000. The variables for the prediction models were selected from the USRDS files: PATIENT (patient's demographic data), RXHIST60 (patient's ESRD history), TX (transplant data), TXUNOS (baseline detailed transplant data), TXFUUNOS (follow-up transplant data). For recipients of multiple transplants the most recent one was considered the target transplant (transplant of interest). Patient records with missing information regarding graft or patient survival were excluded from the study. A total of 92,844 patients with kidney transplant were identified. Censored data used for multivariate analysis will be excluded from the prediction analysis as described below. Separate datasets were generated for each of the five tree models. These datasets included only uncensored records. For example, for one year prediction only patients with known one year outcome were selected, while those who were censored due to insufficient duration of follow-up were excluded. From each of the datasets ⅔ of the data were randomly selected into the training dataset and the remaining ⅓ into the testing dataset. The training set was used for knowledge acquisition (to generate the model), while validation was performed using the records from the testing set.

### Outcome

The outcome was the time between the most recent kidney transplant and the failure of the graft. For the purpose of the prediction model the outcome was converted into one, two, three, five, seven, and ten year transplant periods as a binary variable. Graft failure definition did not include patient death with functioning graft, recorded in USRDS by a single binary variable. In case the value of this variable was missing and patient death date has been found to be equal to graft failure date, it will be assumed that the patient died with a functioning graft unless the cause of death specified in UNOS file was coded (ICD-9) as one of the following: 3200, graft failure: primary failure; 3201, graft failure: rejection; 3202, graft failure: technical; 3299, graft failure: other; 3903, miscellaneous: renal failure.

### Independent Variables

The following independent variables were considered and evaluated for inclusion in the prediction models.

Recipient demographic and anthropometric data: age, race, gender, height and weight. Information was obtained from USRDS files SAF.PATIENT and SAF.TXUNOS.

Variables describing recipient ESRD course were obtained from SAF.PATIENT and SAF.RXHIST60 files: age at the onset of ESRD, total duration of pre-transplant ESRD period (time between the first ESRD service and most recent transplant date), renal replacement therapy modality immediately prior to current transplant, predominant RRT modality during ESRD course (defined as modality used for >50% of the ESRD period as previously described (37)), number of different RRT modalities used, the specific combination of RRT modalities, absolute time and percent time of the whole ESRD period that the patient was treated with a specific RRT modality, history of transplants prior to the current one (yes/no), and total number of transplants (including the current one). Since preemptive transplant was reported to be advantageous to graft survival (21, 32, 38), the binary variable defining preemptive transplant was considered for inclusion in the models. Definition of preemptive transplant can be done by the variable PRTXDIAL from SAF.TXUNOS file as was done by other researchers (32). However, alternatively, since the PRTXDIAL variable was not collected prior to 1995, we defined preemptive transplant from SAF.RXHIST60 file, based on duration of ESRD and use of dialysis prior to the transplant of interest as described before (39). Dialysis network was used as a proxy for geographic location.

Recipient comorbidity status was described by a composite comorbidity index similar to one proposed by Davies, which has been shown to be strongly associated with outcome in ESRD patients (40). Other comorbidity indices were proposed in the literature, and since it has been demonstrated that Khan, Davies, and Charlson scores are appropriate for expressing the prognostic impact of comorbidity on mortality risk in patients with ESRD (41, 42), the Davies approach was selected for its simplicity. Also, specific comorbid conditions used as separate variables were considered for the model: presence and duration of HTN and DM, history of coronary artery disease, symptomatic cerebrovascular disease, symptomatic peripheral vascular disease, history of malignant tumors, recipient medical conditions at listing and functional status prior to transplant. Information about coexisting conditions was obtained from the SAF.TXUNOS file, which was collected from the Transplant Candidate Registration Form prior to transplant (at the time of listing for the most recent transplant).

Donor variables: type of donor (deceased or living), age, race, gender, height, and weight, donor condition prior to donation (presence and duration of comorbidities: DM, HTN, CAD, smoking history, heartbeating or not, cause/mechanism of death) were obtained from the SAF.TXUNOS file.

Transplant procedure variables were also obtained from the SAF.TXUNOS file: cold ischemia time, transplant procedure type (e.g., single kidney, kidney-pancreas, double kidney transplant), transplant center where surgery was done, donor and recipient HLA match, maintenance immunosuppressive therapy at the time of discharge from the hospital (latter will be obtained from the SAF.TXIRUNOS file).

### Variable Selection

Several strategies were used to select the predictors for the model. The selection criteria were based on the predictive value of the variable weighted against the practicality of including it in the model. Even though the longer list of the predictors may potentially improve the outcome of the model, using too many variables may compromise the practical usefulness of the model in the clinical setting. In particular, since the decision support tool is intended to be used in the pre-transplant clinical environment, only variables available before the transplant procedure were used in developing prediction algorithms.

Survival analysis. Survival analysis was performed using proportional hazards regression modeling for the purpose of identifying the set of predictors of graft survival. For the survival analysis, where outcome was analyzed as time to event, allograft outcome was censored at the earliest of the following events: loss to follow-up, patient death, or study completion date (Dec. 31, 2003) and was analyzed as days to graft failure or censor. For the purpose of variable selection the survival analysis was supplemented by the logistic regression models as described below.

Logistic regression modeling for variable selection. Five separate logistic regression models were generated predicting graft survival as a binary variable at 1, 3, 5, 7, and 10 years of follow-up. A conservative approach to variable selection was used. Only variables that had significant association with the outcome in at least 1 out of 5 models were included in the final tree-based analysis—in other words, variables that were not significant in at least one model were excluded.

Additional variables. In addition, variables excluded by the criteria described above were later included. These variables were considered to be important for the graft outcome prediction: recipient history of unstable angina, predominant renal replacement therapy modality in the pre-transplant course and percent time on peritoneal dialysis (37), recipient history of hypertension, recipient gender, and donor gender.

Additional selection. Using the strategies described above, the tree-model for convergence was tested and demonstrated poor performance, which is explained by potential collinearity in the data. To make the model more practical and parsimonious, the performance of the model was evaluated with a shorter list of variables, excluding variables that were considered non-essential. Heartbeating donor variable was found to have a lot of missing information, while non-missing data was collinear with donor type (living vs. deceased). The variables describing cardiovascular disease history were collinear with the variable describing peripheral vascular disease history; therefore, the latter was removed. The variable describing the use of antihypertensive medications by the donor was largely homogenous and was also removed. RRT modality immediately prior to transplant was not used. Instead, predominant RRT modality during ESRD course was included in the model. Also excluded was the variable describing the dialysis network, since the model did not converge in its presence. The performance of the tree-based and regression models using long and short lists of the variables was compared using R-squared and no differences were found in the outcome. A shorter list of variables (below) was used for the prediction model construction.

Final list of predictors. The final list included the following recipient variables: race, gender, age, height, weight, having a transplant prior to the current one (yes/no), total number of transplants (including the current one), the time recipient has been on the list prior to transplant, predominant renal replacement therapy modality, percent time on peritoneal dialysis prior to transplant, number of renal replacement therapy modalities used prior to transplant, the specific combination of renal replacement therapy modalities, recipient comorbidity score, history of cardiovascular disease, history of unstable angina, history of diabetes, history of hypertension, presence of hepatitis B core antibodies, presence of hepatitis C antibodies, peak and mean level of panel reactive antibodies, and primary source of pay for medical services.

In addition, the following donor variables were used in the final model: race, gender, age, height, weight, donor type (living or deceased).

Finally, the following transplant procedure variables were also used: cold ischemia time, number of matched HLA antigens, and using MMF in the immunosuppressive regimen (as a proxy for the transplant era).

### Statistical Analysis and Prediction Models

Continuous variables were summarized using means and standard deviations. A tree-based model analysis has been extensively described elsewhere (29) and was successfully used by our group in the prediction of renal function of diabetics (28) and in the prediction of kidney allograft survival (43). Briefly, a tree-based model, also called classification and regression trees or CART, is a form of binary recursive partitioning that systematically separates data into two groups using regression of a single factor on the outcome. Unlike traditional methods, the tree-building techniques are ideally suited for the development of a reliable clinical decision rule that can be used to classify new patients into categories according to predicted allograft outcome, where traditional statistical methods are sometimes cumbersome to use or of limited utility (29). Tree-based modeling works well when the regression variables are a mixture of categorical and continuous variables. The algorithm is non-parametric, so no assumptions are made regarding the underlying distribution of values of the predictor variables. Tree-based modeling requires relatively little input from the analyst; the outcome is presented in a form of binary trees and is easy to interpret by a non-statistician. A limitation of the model is as follows: the partitioning method leads to the predicted value being presented in a discrete format that may not make full use of the information that continuous variables can provide (29).

Validation and performance testing. To test the performance of the models, prediction algorithms were applied to the testing dataset, and the values of the predicted probability of graft failure were generated and compared to actual values of graft outcome. The following measures were used for the validation of the prediction models.

Probability of graft failure predicted on a testing set was categorized into deciles and for each category the rate of graft failure was calculated and compared with the predicted value (43).

Receiver operating characteristic (ROC) curve analysis was used to evaluate and compare performance of the models. ROC (probability that for a randomly chosen pair of patients, the predicted and observed graft survival are concordant) analysis is a non-parametric method used to quantify the accuracy of the prediction. It is a plot of the true positive rate against the false positive rate for the different possible cut-points of a prediction algorithm. It shows the tradeoff between sensitivity and specificity (any increase in sensitivity will be accompanied by a decrease in specificity). The closer the curve follows the left-hand border and then the top border of the ROC space (resulting in a large area under ROC curve: an area of 1 represents a perfect prediction), the more accurate is the model. The closer the curve comes to the 45-degree diagonal of the ROC space (resulting in a smaller area under ROC curve: an area of 0.5 represents a worthless prediction), the less accurate is the model. The procedure ROCCOM in the software package STATA (Stata Corporation, College Station, Tex.) was used to calculate and compare the area under the ROC curves.

### Software

SAS (SAS Institute, Cary, N.C.) was used for descriptive statistics and survival analysis, S-Plus (Insightful, Seattle, Wash.) was used for logistic regression and tree-based modeling (28, 43), and STATA (Stata Corporation, College Station, Tex.) was used for ROC analysis.

### Results

### Descriptive Statistics

Data were collected from USRDS and included 92,844 records of patients receiving kidney or kidney-pancreas transplants starting Jan. 1, 1990 and through Dec. 31, 1999. The study population characteristics are presented in Table 5. Average age was 43.3 years, there were 60.3% male, 70.2% white, and 27.2% diabetics, 77.1% of patients were on HD prior to transplant, 12.6% had another kidney transplant prior to the current transplant. The graft failed during 11 years of the study period in 34.9% of patients. Cold ischemia time was on average 15.5 hours.

TABLE 5
Baseline characteristics of the of kidney transplant recipients
(n = 92,844) at the time of the most recent transplantation¹
Recipient characteristics

| | |
|---|---|
| Age (yrs) | 43.3 ± 14.2 |
| Gender (males) | 60.3% |
| Race (White, African American, Asian, Native American) | 70.2%, 23.0%, 3.4%, 0.9% |
| Weight (kg) | 72.6 ± 17.2 |
| Height (cm) | 169.0 ± 13.7 |
| Primary cause of end-stage renal disease | |
| DM | 25.2% |
| HTN | 17.2% |
| Glomerulonephritis | 25.8% |
| Cystic disease | 7.6% |
| Other | 24.2% |
| Comorbidity score² | 0.8 ± 0.8 |
| History of diabetes | 27.2% |
| History of hypertension | 52.5% |
| Total duration of end-stage renal disease (yrs) | 3.1 ± 3.6 |
| Percent of end-stage renal disease duration time on peritoneal | 22.8 ± 38.0 |
| dialysis³ | |
| Percent of end-stage renal disease duration time on | 67.3 ± 41.5 |
| hemodialysis³ | |
| Percent of total end-stage renal disease duration with | 6.1 ± 20.1 |
| transplant³ | |
| Renal replacement therapy modality immediately prior to | |
| transplant | |
| Hemodialysis | 71.3% |
| Peritoneal dialysis | 21.8% |
| Transplant (dialysis free re-transplant) | 1.1% |
| Unknown | 5.8% |
| Predominant renal replacement therapy modality⁴ | |
| Hemodialysis | 67.3% |
| Peritoneal dialysis | 22.6% |
| Transplant | 6.4% |
| None | 3.6% |
| Total number of transplants (including the current one) | 1.2 ± 0.4 |
| Time on the transplant list (yrs) | 1.3 ± 1.1 |
| Peak reactive antibody level (%) | 12.1 ± 21.5 |
| Mean reactive antibody level (%) | 5.3 ± 14.7 |
| Number of matched HLA antibodies | 1.8 ± 1.5 |
| Cold ischemia time (hr) | 15.5 ± 8.7 |
| Transplant day of the week⁵ | 4.0 ± 1.8 |
| History of previous kidney transplant(s) | 12.6% |

Donor characteristics

| | |
|---|---|
| Age (yrs) | 34.4 ± 15.5 |
| Gender (males) | 56.2% |
| Race (White, African American, Asian, Native American) | 82.5%, 11.5%, 1.3%, 0.4% |
| Weight (kg) | 72.8 ± 19.0 |
| Height (cm) | 164.3 ± 21.9 |
| Terminal serum creatinine level (mg/dL) | 0.9 ± 0.3 |
| Terminal blood urea nitrogen level (mg/dL) | 12.1 ± 6.1 |
| Living donors | 24.8% |

¹Continuous variables presented as mean ± standard deviation
²The comorbidity score used in our study was calculated based on the following coexisting conditions, each of them contributing one point: cardiovascular disease (defined in USRDS as symptomatic cardiovascular disease or angina/coronary artery disease), symptomatic peripheral vascular disease, diabetes mellitus, and hypertension.
³Information obtained from the USRDS RXHIST file. Due to missing/unknown data and the “60 days rule” convention adopted by USRDS (see text) the total is less than 100%.
⁴Predominant renal replacement therapy modality is defined as the modality used for >50% of the duration of end-stage renal disease
⁵Transplant day of the week is expressed in numbers starting with Sunday (1 = Sunday, 2 = Monday, etc.).

Tree-based model generation

TBM design. Five different tree-based models predicting the probability of the allograft survival for 1, 3, 5, 7, and 10 years were generated. TBM were initially generated without restrictions using the limited list of independent variables described above. To generate final, more parsimonious models the optimal number of terminal nodes was determined for each model using a cross-validation procedure, where the deviance was plotted against the size of the tree to select the optimal tree size. The optimal size of the tree was identified as 93 for the model predicting 1 year survival, 40 for 3 year survival, 88 for 5 year survival, and 65 for 7 year survival. The cross-validation procedure did not indicate the optimal tree-size for the 10 year outcome model; therefore, we arbitrarily selected the model with 65 terminal nodes (same as for 7 year outcome prediction). Following that the second set of tree models was generated pruned to the size identified by the cross-validation procedure. After the models were created, the set of predicted outcome values was generated in the testing datasets.

The residual mean deviance of the model and misclassification error rate are presented in Table 6.

TABLE 6
The residual mean deviance of and misclassification error of the
prediction models. The 50% cut-point of the predicted probability
of graft survival was used to convert it into a binary variable to
calculate the misclassification error.

| Model | Residual mean deviance | Misclassification error |
|---|---|---|
| One year survival | 0.76 | 0.14 |
| Three years survival | 1.13 | 0.27 |
| Five years survival | 1.18 | 0.32 |
| Seven years survival | 0.89 | 0.25 |
| Ten years survival | 0.35 | 0.08 |

Model validation

Correlation analysis. The predicted variable in this study is the probability of graft survival, which is a continuous variable. The actual outcome for each individual patient however is binary (yes/no), making it impossible to perform the correlation between actual and predicted outcome. Therefore, we had to resort to the following strategy. All records were divided into 10 groups based on predicted probability of graft survival using the following cut-points: 0-10%, >10-20%, >20-30%, >30-40%, >40-50%, >50-60%, >60-70%, >70-80%, >80-90%, >90-100%. The observed graft survival was calculated for each group and compared to the predicted probability. If the number of patients in a particular group was low (arbitrarily selected value of <30), it was merged with next group up, except for the very last group, that was merged with the next group down. In particular, for the 1 year prediction model the models did not make any predictions with the probability of graft survival 0-10% and 11-20%; therefore, these groups were merged with the group where predicted probability of graft survival was 21-30%. Similarly, the 31-40% group had only 7 patients and therefore was merged with the 41-50% group. In the 3 year prediction model none of the groups with predicted probability between 0 and 30% had any patients and therefore were merged with the 31-40% group. In the 5 year model the last group 91-100% had 13 patients and was merged with the 81-90% group. For the 7 year prediction, the 91-100% group had only 21 patients and was merged with the 81-90% group. Finally, for the 10 year prediction, none of the groups greater than 60% had enough patients and were merged together in the 61-100% group.

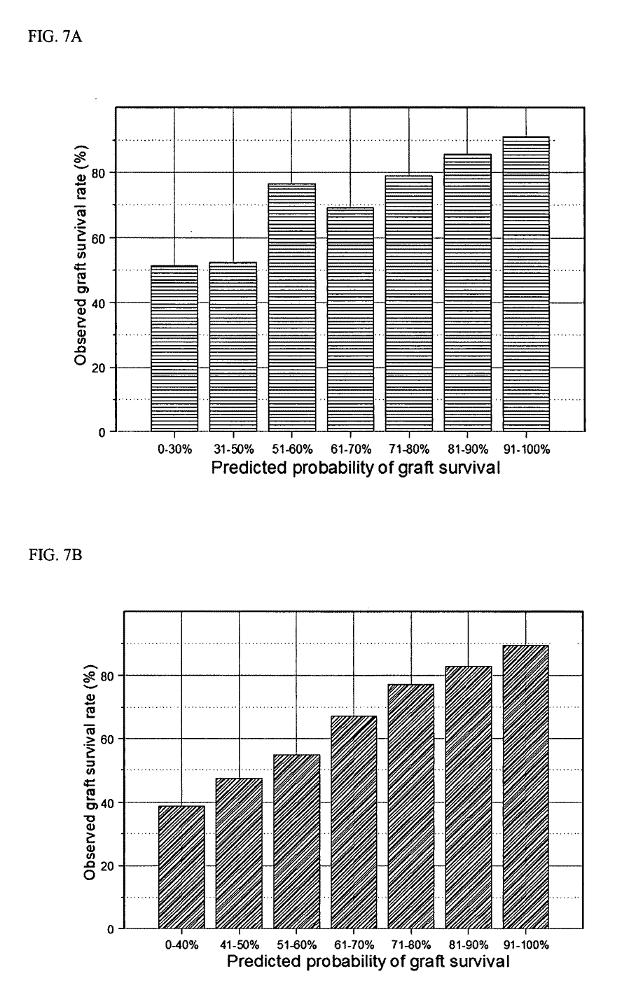

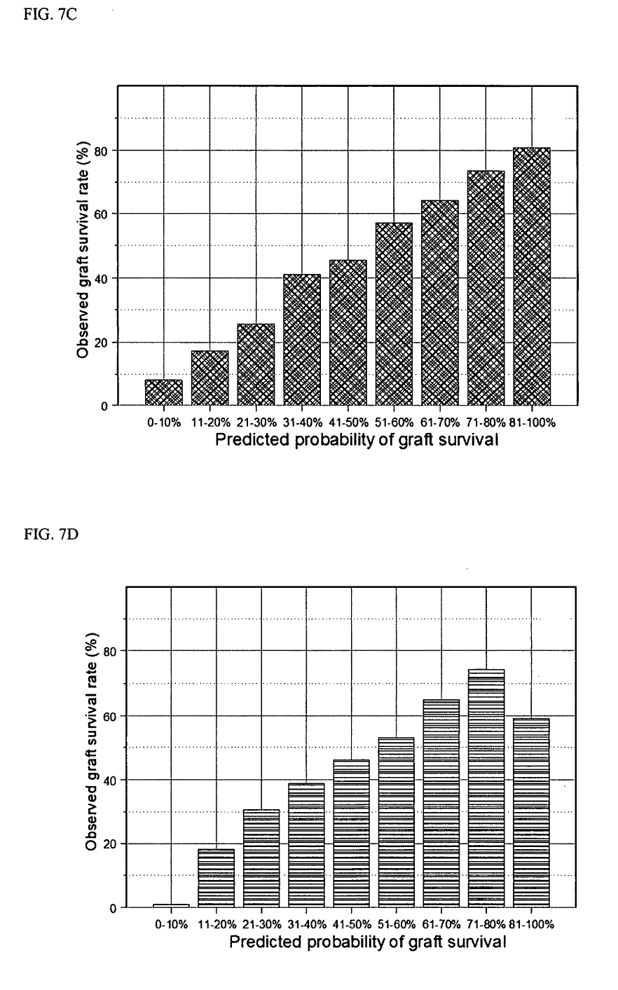

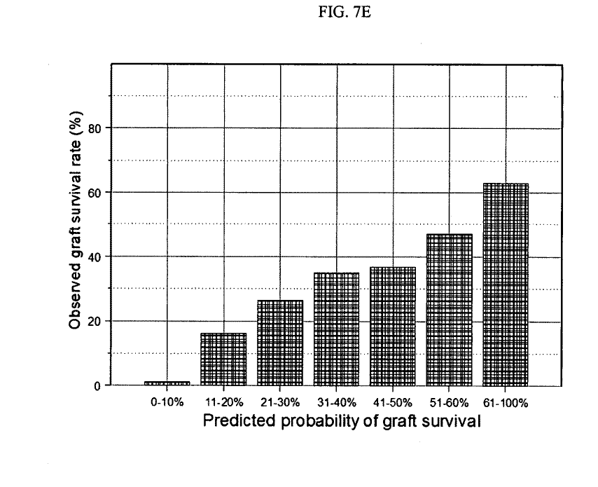

The results of the analysis are presented in Table 7, where the percent of actual graft survival and number of patients for each of the groups of predicted probability of graft survival is presented. These results are illustrated in FIGS. 7A-7E.

TABLE 7
All records were divided into groups based on predicted probability of
graft survival. The actual survival rate and number of patients in each
group are presented in this table.

| | | | | | | | | | | |
|---|---|---|---|---|---|---|---|---|---|---|
| 1 year | Predicted probability | 0-30% | 31-50% | 51-60% | 61-70% | 71-80% | 81-90% | 91-100% | | |
| survival | of survival | | | | | | | | | |
| | Percent survival | 51.5 | 52.5 | 76.5 | 69.0 | 78.9 | 85.7 | 91.2 | | |
| | n | 33 | 139 | 162 | 924 | 4479 | 15598 | 11509 | | |
| 3 year | Predicted probability | 0-40% | 41-50% | 51-60% | 61-70% | 71-80% | 81-90% | 91-100% | | |
| survival | of survival | | | | | | | | | |
| | Percent survival | 38.8 | 47.4 | 54.9 | 67.1 | 77.0 | 82.7 | 89.3 | | |
| | n | 474 | 274 | 1914 | 7907 | 8598 | 3746 | 759 | | |
| 5 year | Predicted probability | 0-10% | 11-20% | 21-30% | 31-40% | 41-50% | 51-60% | 61-70% | 71-80% | 81-100% |
| survival | of survival | | | | | | | | | |
| | Percent survival | 8.2 | 17.2 | 25.6 | 41.2 | 45.5 | 57.0 | 64.0 | 73.6 | 81.0 |
| | n | 981 | 1123 | 520 | 1241 | 1777 | 4092 | 4262 | 2791 | 1218 |
| 7 year | Predicted probability | 0-10% | 11-20% | 21-30% | 31-40% | 41-50% | 51-60% | 61-70% | 71-80% | 81-100% |
| survival | of survival | | | | | | | | | |
| | Percent survival | 0.9 | 18.1 | 30.7 | 38.9 | 46.0 | 53.1 | 64.9 | 74.3 | 59.2 |
| | n | 5307 | 548 | 807 | 792 | 2860 | 2537 | 2541 | 1323 | 76 |
| 10 year | Predicted probability | 0-10% | 11-20% | 21-30% | 31-40% | 41-50% | 51-60% | 61-100% | | |
| survival | of survival | | | | | | | | | |
| | Percent survival | 1.2 | 16.1 | 26.4 | 34.9 | 36.9 | 47.0 | 62.9 | | |
| | n | 7488 | 1181 | 367 | 521 | 485 | 202 | 35 | | |

The midpoint of each group's probability range was used as the predicted percent survival for the group and compared to observed graft survival for the group by correlation analysis. The prediction of the probability of graft survival from the training model achieved a good correlation with the observed survival of the testing set with r=0.94 for 1 year survival prediction, r=0.98 for 3 years survival prediction, r=0.99 for 5 year survival prediction, r=0.93 for 7 year survival prediction, and r=0.98 for 10 year survival prediction.

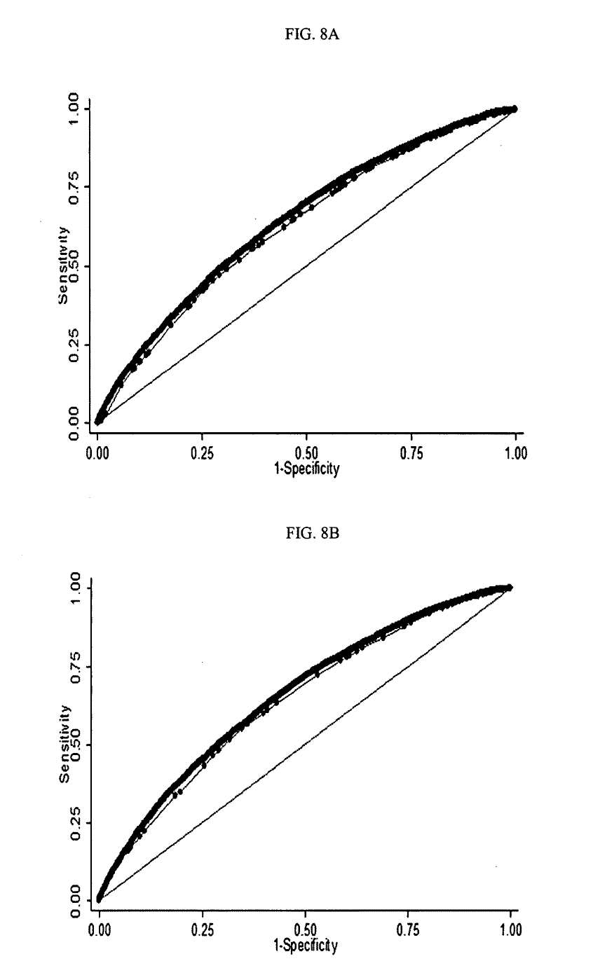

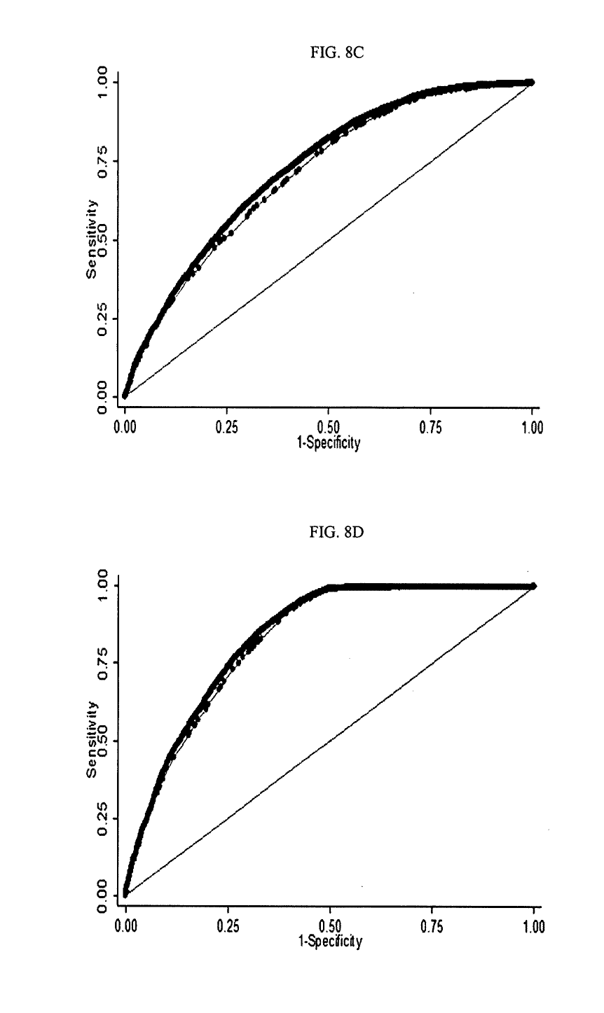

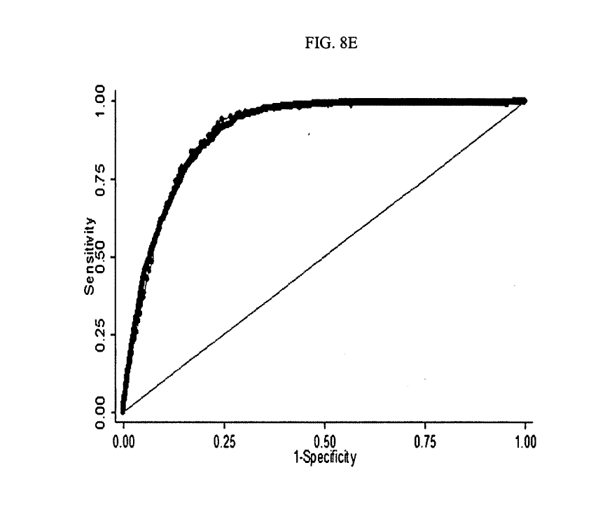

Receiver operator characteristics (ROC) curve analysis. The ROC analysis was performed for each model using the predictions generated on the testing dataset. The ROC curves are presented in FIGS. 8A-8E. The area under the ROC curve was calculated for each model using the prediction data generated on the testing dataset. All models achieved a reasonable prediction accuracy on the independent testing dataset. For 1 year prediction the area under the ROC curve was 0.63 (FIG. 8A), for 3 year prediction: 0.64 (FIG. 8B), for 5 year prediction: 0.71 (FIG. 8C), for 7 year prediction: 0.82 (FIG. 8D), and for 10 year prediction: 0.90 (FIG. 8E).

While this invention has been described in certain embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### REFERENCES

### The Contents of Each of which is Incorporated by this Reference in its Entirety

1. Halloran P. F., A. Melk and C. Barth. Rethinking chronic allograft nephropathy: the concept of accelerated cenescence. J. Am. Soc. Nephrol. 1999: 10:167.
2. Cecka J. M. The UNOS Scientific Renal Transplant Registry. In: J. M. Cecka and P. I. Terasaki, eds. Clinical Transplants. Los Angeles: UCLA Immunogenetics Center, 1999.
3. Gjertson D. W. Determinants of long-term survival of adult kidney transplants: a 1999 UNOS update. In: J. M. Cecka and P. I. Terasaki, eds. Clinical Transplants. Los Angeles: UCLA Immunogenetics Center, 1999.
4. Gjertson D. W. and J. M. Cecka. Determinants of long-term survival of pediatric kidney grafts reported to the United Network for Organ Sharing kidney transplant registry. Pediatr. Transplant 2001: 5:5.
5. Ishitani M., R. Isaacs, V. Norwood, S. Nock, and P. Lobo. Predictors of graft survival in pediatric living-related kidney transplant recipients. Transplantation 2000: 70:288.
6. Tejani A., D. M. Stablein, L. Donaldson, et al. Steady improvement in short-term graft survival of pediatric renal transplants: the NAPRTCS experience. In: J. M. Cecka and P. I. Terasaki, eds. Clinical Transplants. Los Angeles: UCLA Immunogenetics Center, 1999.
7. Terasaki P. I., D. W. Gjertson, J. M. Cecka, S. Takernoto, and Y. W. Cho. Significance of the donor age effect on kidney transplants. Clin. Transplant 1997: 11:366.
8. Alexander J. W., L. E. Bennett, and T. J. Breen. Effect of donor age on outcome of kidney transplantation. Transplantation 1994: 57:871.
9. Ojo A. O., A. B. Leichtman, J. D. Punch, et al. Impact of preexisting donor hypertension and diabetes mellitus on cadaveric renal transplant outcomes. Am. J Kidney Dis. 2000: 36:153.
10. Sanchez-Fructuoso A. I., D. Prats, J. Torrente, et al. Renal transplantation from non-heart beating donors: a promising alternative to enlarge donor pool. J. Am. Soc. Nephrol. 2000: 11:350.
11. Jordan M. L., R. Shapiro, C. A. Vivas, et al. High-risk donors: expanding donor criteria. Transplant Proc. 1999: 31:1401.
12. Remuzzi G., J. Grinyo, P. Ruggenenti, et al. Early experience with dual kidney transplantation in adults using expanded donor criteria. J. Am. Soc. Nephrol. 1999: 10:2591.
13. Karpinski J., G. Lajoie, D. Cattran, et al. Outcome of kidney transplantation from high-risk donors is determined by both structure and function. Transplantation 1999: 67:1162.
14. Hariharan S. Long-term kidney transplant survival. Am. J Kidney Dis. 2001: 38 (Suppl. 6):S44.
15. Young C. J. and R. S. Gaston. African Americans and renal transplantation: disproportionate need, limited access, and impaired outcomes. Am. J. Med. Sci. 2002: 323:94.
16. Bleyer A. J., L. A. Donaldson, M. McIntosh, and P. L. Adams. Relationship between underlying renal disease and renal transplantation outcome. Am. J Kidney Dis. 2001: 37:1152.
17. Mouquet C., H. Benalia, E. Chartier-Kastler, et al. Renal retransplantation in adults. Comparative prognostic study. Progres en Urologie 1999: 9:239.
18. Chavers B. M., E. K. Sullivan, A. Tejani, and W. E. Harmon. Pretransplant blood transfusion and renal allograft outcome: a report of the North American Pediatric Renal Transplant Cooperative Study. Pediatr. Transplant 1997: 1:22.
19. Kim S. T., S. Lee, J. S. Kim, J. Ha, J. K. Chung, and S. J. Kim. Analysis of the factors affecting survival of renal transplant recipients. Transplant Proc. 1998: 30:3086.
20. VanBiesen, R. Vanholder, and N. Lameire. Impact of pretransplantation dialysis modality on patient outcome after renal transplantation: the role of peritoneal dialysis revisited. Perit. Dial. Int. 1999: 19:103.
21. Mange K. C., M. M. Joe, and H. Feldman. Effect of the use or nonuse of long-term dialysis on the subsequent survival of renal transplants from living donors. N. Engl. J. Med. 2001: 344:726.
22. Terasaki P. I. and J. M. Cecka. The center effect: is bigger better? In: J. M. Cecka and P. I. Terasaki, eds. Clinical Transplants. Los Angeles: UCLA Immunogenetics Center, 1999.
23. Lin H. M., H. M. Kauman, M. A. McBride, et al. Center-specific graft and patient survival rates: 1997 United Network for Organ Sharing (UNOS) report. JAMA 1998: 280:1153.
24. Nyberg S. L., A. J. Matas, M. Rogers, et al. Donor scoring system for cadaveric renal transplantation. Am. J. Transpl. 2001: 1:162.
25. Hennige M., C. O. Kohler, and G. Opelz. Multivariate prediction model of kidney transplant success rates. Transplantation 1986: 42:491.
26. Shoskes D. A., R. Ty, L. Barba, and M. Sender. Prediction of early graft function in renal transplantation using a computer
27. Landis J. R. and G. G. Koch. The measurement of observer agreement for categorical data. Biometrics 1977: 33:159.
28. Goldfarb-Rumyantzev A. S. and L. Pappas. Prediction of renal insufficiency in Pima Indians with nephropathy of type 2 diabetes mellitus. Am. J Kidney Dis. 2002: 40:252.
29. Breiman L., J. H. Friedman, R. A. Olshen, and C. J. Stone. Classification and Regression Trees. Monterey, Calif.: Wadsworth and Brooks/Cole, 1984.
30. Degawa H., T. Nemoto, M. Uchiyama, et al. Effect of donor age on renal allograft survival. Transplant Proc. 1998: 30:3660.
31. Meier-Kriesche H. U., F. K. Port, A. O. Ojo, et al. Effect of waiting time on renal transplant outcome. Kidney Int. 2000: 58:1311.
32. Kasiske B. L., J. J. Snyder, A. J. Matas, M. D. Ellison, J. S. Gill, and A. T. Kausz. Preemptive kidney transplantation: the advantage and the advantaged. J. Am. Soc. Nephrol. 2002: 13:1358.
33. Meier-Kriesche H. U., M. Vaghela, R. Thambuganipalle, G. Friedman, M. Jacobs, and B. Kaplan. The effect of body mass index on long-term renal allograft survival. Transplantation 1999: 68:1294.
34. Howard R. J., V. B. That, P. R. Patton, et al. Obesity does not portend a bad outcome for kidney transplant recipients. Transplantation 2002: 73:53.
35. Healey P. J., R. McDonald, J. H. Waldhausen, R. Sawin, and D. Tapper. Transplantation of adult living donor kidneys into infants and small children. Arch. Surg. 2000: 135:1035.
36. Poli F., M. Scalamogna, M. Cardillo, E. Porta, and G. Sirchia. An algorithm for cadaver kidney allocation based on a multivariate analysis of factors impacting on cadaver kidney graft survival and function. Transpl. Int. 2000: 13 (Suppl. 1):S259.
37. Goldfarb-Rumyantzev A S, Hurdle J F, Scandling J D, Baird B C, Cheung A K: The role of pretransplantation renal replacement therapy modality in kidney allograft and recipient survival. Am J Kidney Dis 46:537-549, 2005.
38. Meier-Kriesche H, Port F K, Ojo A O, Leichtman A B, Rudich S M, Arndorfer J A, Punch J D, Kaplan B: Deleterious effect of waiting time on renal transplant outcome. Transplant Proc 33:1204-1206, 2001.
39. Goldfarb-Rumyantzev A, Hurdle J F, Scandling J, Wang Z, Baird B, Barenbaum L, Cheung A K: Duration of end-stage renal disease and kidney transplant outcome. Nephrol Dial Transplant 20:167-175, 2005.
40. Davies S J, Russell L, Bryan J, Phillips L, Russell G I: Comorbidity, urea kinetics, and appetite in continuous ambulatory peritoneal dialysis patients: their interrelationship and prediction of survival. Am J Kidney Dis 26:353-361, 1995.
41. Van Manen J G, Korevaar J C, Dekker F W, Boeschoten E W, Bossuyt P M, Krediet R T: How to adjust for comorbidity in survival studies in ESRD patients: a comparison of different indices. Am J Kidney Dis 40:82-89, 2002.
42. Van Manen J G, Korevaar J C, Dekker F W, Boeschoten E W, Bossuyt P M, Krediet R T: Adjustment for comorbidity in studies on health status in ESRD patients: which comorbidity index to use? J Am Soc Nephrol 14:478-485, 2003.
43 Goldfarb-Rumyantzev A S, Scandling J D, Pappas L, Smout R J, Horn S: Prediction of 3-yr cadaveric graft survival based on pre-transplant variables in a large national dataset. Clin Transplant 17:485-497, 2003.

What is claimed is:

1. A method of predicting a probability of graft survival, said method comprising:
selecting pre-transplant variables using a logistic regression model;
generating a graft survival algorithm using a tree based model; and
calculating the probability of graft survival using the pre-transplant variables and the graft survival algorithm.

2. The method according to claim 1, wherein the pre-transplant variables are selected from the group consisting of recipient having a transplant prior to the current one (yes/no), total number of transplants (including the current one), the time recipient has been on the list prior to transplant, predominant renal replacement therapy modality, percent time on peritoneal dialysis prior to transplant, number of renal replacement therapy modalities used prior to transplant, the specific combination of renal replacement therapy modalities, recipient comorbidity score, history of cardiovascular disease, history of unstable angina, presence of hepatitis B core antibodies, presence of hepatitis C antibodies, peak and mean level of panel reactive antibodies, primary source of pay for medical services, donor living or deceased, use of MMF in the immunosuppressive regimen, and combinations thereof.

3. The method according to claim 1, further comprising:
developing a computer software program comprising a logistic regression model for selecting the pre-transplant variables and for generating the graft survival algorithm;
calculating the probability of graft survival by using the computer software program;
storing donor and recipient pre-transplant variables using the computer software program; and
selecting appropriate organ donors and recipients in order to optimize the probability of graft survival.

4. The method according to claim 3, wherein the probability of graft survival is calculated for a certain period of time.

5. The method according to claim 3, wherein the certain period of time is selected from the group consisting of 1, 3, 5, 7, and 10 years.

6. The method according to claim 3, wherein the probability of graft survival is used to decide if a potential graft recipient should be transplanted or not.

7. A method of advising a potential allograft recipient, the method comprising:
determining the probability of graft survival according to the method of claim 1; and
advising the potential allograft recipient as to the probability of graft survival.

8. The method according to claim 7, wherein the probability of graft survival is determined for a period selected from the group consisting of 1 year, 3 years, 5 years, 7 years, 10 years, and combinations thereof.

9. A method of providing decision support for a graft implantation, the method comprising:
selecting pre-transplant variables;
calculating the probability of graft survival for each of more than one graft survival algorithm; and
using the calculated probability of graft survival to aid in a decision to implant a graft.

10. The method according to claim 9, wherein the more than one graft survival algorithms are selected from the group consisting of tree-based models, multilinear regressions models, artificial neural networks, and generalized additive models.

11. The method according to claim 9, wherein the pre-transplant variables are selected from the group consisting of recipient having a transplant prior to the current one (yes/no), total number of transplants (including the current one), the time recipient has been on the list prior to transplant, predominant renal replacement therapy modality, percent time on peritoneal dialysis prior to transplant, number of renal replacement therapy modalities used prior to transplant, the specific combination of renal replacement therapy modalities, recipient comorbidity score, history of cardiovascular disease, history of unstable angina, presence of hepatitis B core antibodies, presence of hepatitis C antibodies, peak and mean level of panel reactive antibodies, primary source of pay for medical services, donor living or deceased, use of MMF in the immunosuppressive regimen, and combinations thereof.

12. The method according to claim 9, further comprising averaging the calculated probability of graft survival for each of more than one graft survival algorithm.
